(19) United States
(12) Patent Application Publication
(10) Pub. No.: US 2009/0015733 A1
(43) Pub. Date: Jan. 15, 2009

(54) Retardation Film and Projection Display Apparatus

(75) Inventor: Kosuke Chidate, Chino-shi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 12/136,203

(22) Filed: Jun. 10, 2008

(30) Foreign Application Priority Data
Jul. 13, 2007 (JP) 2007-184023

(51) Int. Cl. G02B 1/08; G02F 1/1335

(52) U.S. Cl. 349/5; 359/485

(57) ABSTRACT

A retardation film includes a substrate, concave-and-convex regions formed on the substrate and arranged at a pitch smaller than a wavelength of visible light, each of the concave-and-convex regions having a concave portion and a convex portion, and an inorganic film formed on the concave-and-convex regions by depositing an inorganic material on the concave-and-convex regions in a direction oblique to a surface of the substrate.

### BACKGROUND

1. Technical Field

The present invention relates to a technical field of a retardation film used with, for example, a light valve used in a projection display apparatus, such as a liquid crystal projector, to control the phase of light entering or leaving a liquid crystal device constituting the light valve.

2. Related Art

JP-A-2006-119444, for example, discloses a retardation film of this type having a substrate and an inorganic film formed thereon by oblique deposition. Such a retardation film is less likely to be deteriorated by light and has a higher light stability than a retardation film having an organic film. In such a retardation film, the inorganic film needs to be thickened to correct the phase difference of light caused by the optical activity and the birefringence of liquid crystal molecules. Therefore, the inorganic film becomes opaque, i.e., creates haze, and diffuses light, thereby lowering the contrast of displayed images.

In order to solve the above-described problem, JP-A-8-122523, for example, discloses a retardation film thinned over the entirety thereof by forming inorganic films on both surfaces of a substrate by vapor deposition. JP-A-10-81955 discloses a retardation film having an inorganic film formed by alternately performing oblique deposition and perpendicular deposition.

However, in the retardation films disclosed in JP-A-8-122523 and JP-A-10-81955, formation of the inorganic films by oblique deposition involves several steps. Therefore, even though generation of haze can be reduced, the process of manufacturing the retardation film becomes complex, which is problematic from the standpoint of the manufacturing process. There is also a technical problem in that control of the phase difference produced by the retardation films becomes difficult when oblique deposition involves several steps.

### SUMMARY

An advantage of some aspects of the invention is that it provides a retardation film for optical compensation, which can be manufactured through a simple process, for example.

A retardation film according to a first aspect of the invention includes a substrate, concave-and-convex regions formed on the substrate and arranged at a pitch smaller than a wavelength of visible light, each of the concave-and-convex regions having a concave portion and a convex portion, and an inorganic film formed on the concave-and-convex regions by depositing an inorganic material on the concave-and-convex regions in a direction oblique to a surface of the substrate.

In the retardation film according to the first aspect of the invention, the concave-and-convex regions are formed on a transparent substrate, such as a glass substrate, and each have the concave portion and the convex portion. The concave-and-convex regions, each having a pair of the concave portion and the convex portion, are arranged at a pitch smaller than the wavelength of visible light.

The inorganic film is formed on the concave-and-convex regions by depositing an inorganic material, such as Ta₂O₅, on the concave-and-convex regions in a direction oblique to the surface of the substrate. Examples of methods available for forming the inorganic film include oblique deposition and sputtering, in which atoms of an inorganic material are deposited on the concave-and-convex regions in a direction oblique to the surface of the substrate. When viewed microscopically, the inorganic film has a structure in which the inorganic material has been grown obliquely. Such an inorganic film has an anisotropic refractive index according to the structure of the inorganic film and according to the entire structure of the concave-and-convex regions depending on the pitch thereof. Therefore, such an inorganic film can more effectively control the phase of light entering the retardation film than a retardation film having only the concave-and-convex regions or a retardation film having the inorganic film formed on a flat surface by oblique deposition.

Accordingly, the retardation film according to the first aspect of the invention can control the phase of light while having a reduced thickness compared to a retardation film having an inorganic film formed on a flat surface of a substrate by oblique deposition or a retardation film having only concave-and-convex regions. In addition, because the inorganic material needs to be deposited on only one surface of the substrate in the retardation film according to the first aspect of the invention, the process of manufacturing the retardation film is simpler than that in which the inorganic film needs to be formed on both surfaces of the substrate. Further, because the inorganic film may be thin in the retardation film according to the first aspect of the invention, generation of haze can be reduced.

In the retardation film according to the first aspect of the invention, it is preferable that the concave-and-convex regions be formed by patterning a resin layer formed by applying resin onto the surface of the substrate.

In such a retardation film, after the resin layer is formed on the substrate, such as a glass substrate, the concave-and-convex regions arranged at a pitch smaller than the wavelength of visible light can be formed using a nano-printing technique.

A retardation film according to a second aspect of the invention includes a substrate, concave-and-convex regions formed by partially removing a surface of the substrate and arranged at a pitch smaller than a wavelength of visible light, each of the concave-and-convex regions having a concave portion and a convex portion, and an inorganic film formed on the concave-and-convex regions by depositing an inorganic material on the concave-and-convex regions in a direction oblique to the surface of the substrate.

In the retardation film according to the second aspect of the invention, the concave-and-convex regions arranged at a pitch smaller than the wavelength of visible light can be formed by anisotropic etching, for example. The inorganic film is formed on the concave-and-convex regions in the same way as the above-described retardation film according to the first aspect of the invention.

Therefore, similarly to the retardation film according to the first aspect of the invention, the retardation film according to the second aspect of the invention can control the phase of light while having a reduced thickness compared to a retardation film having an inorganic film formed on a flat surface of a substrate by oblique deposition, or a retardation film having only concave-and-convex regions. In addition, because the inorganic material needs to be deposited on only one surface of the substrate in the retardation film according to the second aspect of the invention, the process of manufacturing the retardation film is simpler than that in which the inorganic film needs to be formed on both surfaces of the substrate. Further, generation of haze can be reduced.

In the retardation film according to the first and second aspects of the invention, it is preferable that the inorganic film have column-like portions extending from the convex portions toward regions above the concave portions in the direction oblique to the surface of the substrate.

In such a retardation film, the inorganic film has clearances between the column-like portions extending from the convex portions, i.e., spaces above the concave portions. The retardation film having such clearances between the column-like portions can more effectively control the phase of light than a retardation film in which the spaces above the concave portions, i.e., the clearances between the column-like portions extending from the convex portions, are filled with the inorganic material.

In the retardation film according to the first and second aspects of the invention, it is preferable that the pitch be smaller than one-third of the wavelength of visible light.

Such a retardation film can more effectively control the phase of light. More specifically, for example, when the pitch is smaller than the wavelength of a blue light component, which has the shortest wavelength among red, green, and blue light components constituting the three primary colors of light, the phase of all these colored light components can be controlled. When the pitch is smaller than one-third of the wavelength of a blue light component, the phase of all these colored light components can be more effectively controlled.

A projection display apparatus according to a third aspect of the invention includes a liquid crystal device for modulating light, and the above-described retardation film arranged on a light-incident side or light-exiting side of the liquid crystal device.

The projection display apparatus according to the third aspect of the invention realizes a projection display apparatus, such as a liquid crystal projector, capable of displaying high-quality images.

These features and other advantages of the invention will become apparent upon a reading of the following description of exemplary embodiments.

### BRIEF DESCRIPTION OF THE DRAWINGS

The invention will be described with reference to the accompanying drawings, wherein like numbers reference like elements.

FIG. 1 is a plan view showing the entire structure of a liquid crystal device according to a present embodiment.

FIG. 2 is a sectional view of the liquid crystal device shown in FIG. 1, taken along line II-II.

FIG. 3 is a plan view of an exemplary retardation film according to a first aspect of the invention.

FIG. 4 is a sectional view of the retardation film shown in FIG. 3, taken along line IV-IV.

FIG. 5 is an enlarged view of a region V of the retardation film, indicated by a dashed circle in FIG. 4.

FIG. 6 is a sectional view of a modification example of the retardation film according to the first aspect of the invention.

FIG. 7 is a sectional view of an exemplary retardation film according to a second aspect of the invention.

FIG. 8 is a sectional view of a retardation film as a comparative example used in an experiment conducted by the inventor.

FIG. 9 is a perspective view of a retardation film, schematically showing a direction in which the phase difference is measured.

FIGS. 10A and 10B are graphs showing the results of the experiment conducted by the inventor.

FIG. 11 is a plan view of a projector, which is an exemplary projection display apparatus according to the present embodiment.

### DESCRIPTION OF EXEMPLARY EMBODIMENTS

Referring to the drawings, embodiments of a retardation film according to first and second aspects of the invention and a projection display apparatus according to a third aspect of the invention will be described.

### 1. Structure of Liquid Crystal Device

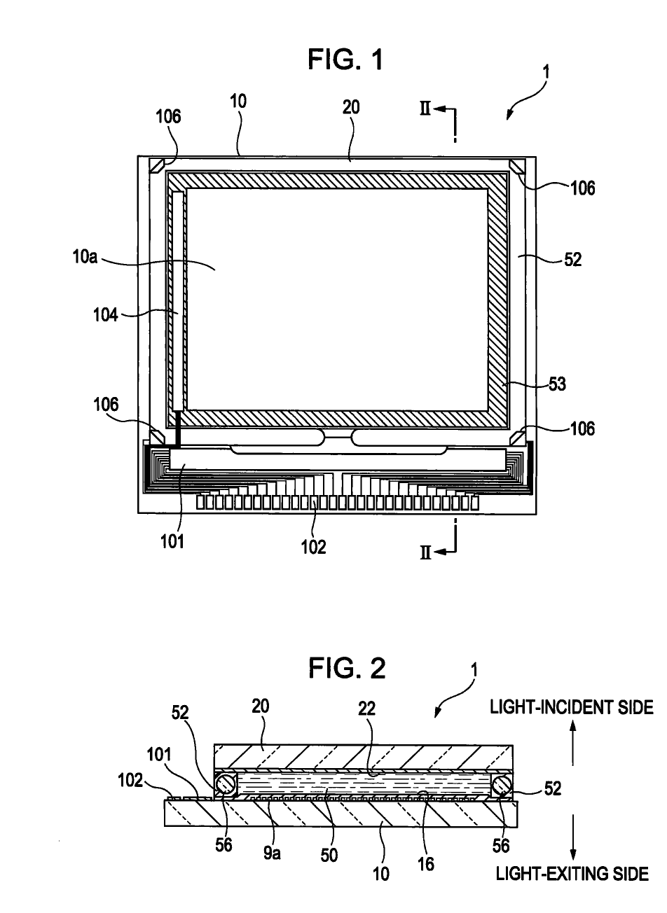

First, referring to FIGS. 1 and 2, a liquid crystal device to be used in a projection display apparatus of an embodiment according to a third aspect of the invention with a below-described retardation film according to the present embodiment will be described. The liquid crystal device according to the present embodiment will be used in a light valve of a projection display apparatus, such as a liquid crystal projector. FIG. 1 is a plan view of the liquid crystal device according to the present embodiment as viewed from a counter substrate side, and FIG. 2 is a sectional view of the liquid crystal device shown in FIG. 1, taken along line II-II. Herein, a liquid crystal device of a TFT active-matrix type having a built-in driving circuit is taken as an example.

In FIGS. 1 and 2, a liquid crystal device 1 has a TFT array substrate 10 and a counter substrate 20 facing each other. A liquid crystal layer 50 is arranged between the TFT array substrate 10 and the counter substrate 20, which are bonded to each other by a sealing material 52 disposed at a seal region located at the periphery of an image-displaying area 10a so as to seal the liquid crystal layer 50 therebetween.

The liquid crystal layer 50 contains twisted nematic (TN) liquid crystal material. When driven, the liquid crystal layer 50 changes the contrast of an image and the transmissivity of the liquid crystal device 1.

The sealing material 52 for bonding the two substrates together is made of, for example, an ultraviolet curable resin or a heat curable resin. In the manufacturing process, the sealing material 52 is applied onto the TFT array substrate 10 and is then cured by being irradiated with ultraviolet rays or by being heated. The sealing material 52 contains gap materials 56, such as glass fibers or glass beads, dispersed therein for maintaining a predetermined distance (gap) between the TFT array substrate 10 and the counter substrate 20.

A frame-shaped light shielding film 53 that defines a frame region of the image-displaying area 10a and blocks light is provided on the counter substrate 20 at a position inside the seal region provided with the sealing material 52, such that it extends parallel to the seal region. However, a part of or the entirety of the frame-shaped light shielding film 53 may be formed on the counter substrate 20, above the electrode, or may be formed on the TFT array substrate 10 as an internal light shielding film.

A data line driving circuit 101 and a plurality of external-circuit connecting terminals 102 are provided along one side of the TFT array substrate 10, in the peripheral region surrounding the image-displaying area 10a and at a position outside the seal region where the sealing material 52 is provided. The liquid crystal device 1 is supplied with driving power and signals through the external-circuit connecting terminals 102 electrically connected to an external circuit, whereby the liquid crystal device 1 is operated. The liquid crystal device 1 according to the present embodiment is a transmissive-mode display, in which, during operation, the upper surface of the counter substrate 20, which overlies the liquid crystal layer 50 in FIG. 2, serves as an incidence surface through which light enters the liquid crystal device 1, and the lower surface of the TFT array substrate 10, which underlies the liquid crystal layer 50 in FIG. 2, serves as an exit surface through which light passing through the liquid crystal device 1 exits. The below-described retardation film according to the present embodiment will be arranged on the incidence surface side or the exit surface side in FIG. 2, when used in the liquid crystal projector with the liquid crystal device 1.

A scanning line driving circuit 104 is provided along one of the two sides adjacent to the side of the TFT array substrate 10 provided with the data line driving circuit 101 and the external-circuit connecting terminals 102 such that it is covered by the frame-shaped light shielding film 53. Alternatively, the scanning line driving circuit 104 may be provided along each of the sides adjoining the above-mentioned side. In this case, the two scanning line driving circuits 104 are connected to each other through a plurality of wires provided along the remaining side of the TFT array substrate 10.

The counter substrate 20 has conductive members 106 arranged at the four corners thereof, which function as conducting terminals for providing conduction between the substrates. The TFT array substrate 10 has conducting terminals arranged at the regions facing the corners of the counter substrate 20. These conducting terminals establish electrical conduction between the TFT array substrate 10 and the counter substrate 20.

Referring to FIG. 2, an alignment film 16 is formed on pixel electrodes 9a, which are formed on the TFT array substrate 10 and provided with thin film transistors (hereinafter, “TFTs”) for switching pixels and lines such as scanning lines and data lines. Although the structure will not be explained in detail here, in the liquid crystal device 1, the electrode formed on the counter substrate 20 faces the pixel electrodes 9a, and an alignment film 22 is formed on the electrode. The TFT array substrate 10 is made of, for example, a transparent substrate composed of a material such as quartz or plastic.

The alignment films 16 and 22 formed on the TFT array substrate 10 and the counter substrate 20, respectively, are made of an organic material, such as polyimide. In the present embodiment, the alignment film may be formed on one of the TFT array substrate 10 and the counter substrate 20, or one of the alignment films formed on the TFT array substrate 10 and the counter substrate 20 may be made of an inorganic material.

The TFT array substrate 10 shown in FIGS. 1 and 2 may have, in addition to the data line driving circuit 101 and the scanning line driving circuit 104, a circuit such as a sampling circuit for sampling image signals transmitted through image signal lines and supplying the data lines with the signals, a precharge circuit for supplying the data lines with precharge signals at a predetermined voltage level prior to the supply of the image signals, and an inspection circuit for inspecting the quality of the liquid crystal device and detecting the presence of failures during manufacturing and shipping.

### 2. Retardation Film

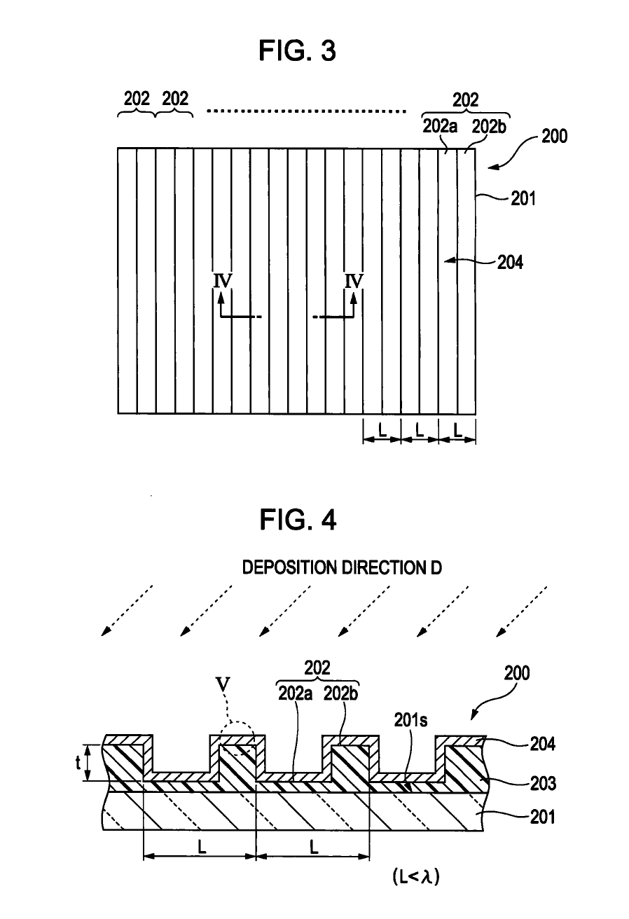

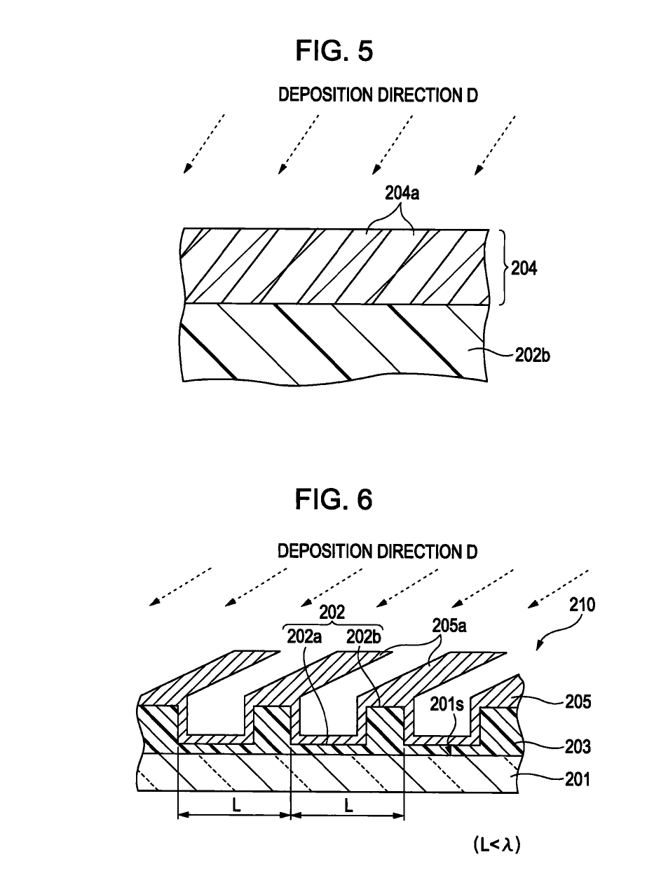

Referring to FIGS. 3 to 6, an exemplary retardation film according to a first aspect of the invention will be described. FIG. 3 is a plan view of an exemplary retardation film according to the first aspect of the invention. FIG. 4 is a sectional view of the retardation film shown in FIG. 3, taken along line IV-IV. FIG. 5 is an enlarged view of a region V of the retardation film, indicated by a dashed circle in FIG. 4.

Referring to FIGS. 3 and 4, a retardation film 200 has a substrate 201, such as a transparent glass substrate, a plurality of concave-and-convex regions 202, each having a concave portion 202a and a convex portion 202b, formed on the substrate 201, and an inorganic film 204 formed on the concave-and-convex regions 202.

The plurality of concave-and-convex regions 202, each having a pair of the concave portion 202a and the convex portion 202b, are formed on the substrate 201. In other words, a concave-and-convex structure having the concave-and-convex regions 202 is formed on the substrate 201. The pitch L of the concave-and-convex regions 202, i.e., the period of the concave-and-convex regions 202 in the concave-and-convex structure, is 100 nm, which is smaller than the wavelength λ of visible light. The depth t is in the range from 50 nm to 200 nm.

The concave-and-convex regions 202 are formed by patterning a flat resin layer 203 formed by applying resin onto the substrate 201. More specifically, the concave-and-convex regions 202 are formed by patterning the resin layer 203 using, for example, a nano-printing technique. The concave-and-convex regions 202 arranged at a pitch smaller than the wavelength of visible light can be formed by using a patterning process.

The inorganic film 204 is formed on the concave-and-convex regions 202 by depositing an inorganic material, such as Ta₂O₅, on the concave-and-convex regions 202 in the deposition direction D shown in FIG. 4, which is a direction oblique to a surface 201s of the substrate 201. As shown in FIG. 5, when viewed microscopically, the inorganic film 204 includes column-like portions 204a, in which the inorganic material has been grown in the deposition direction D. An inorganic film having such a structure produces a certain amount of phase difference due to the fine structure thereof. Because the thickness of the film is too thin in the state shown in FIG. 4, a phase difference sufficient to correct the phase difference produced by a liquid crystal panel may not be produced. Then, the inorganic material is further deposited on the structure shown in FIG. 4 to obtain an inorganic film having the structure schematically shown in FIG. 6. Next, the structure of the retardation film shown in FIG. 6 will be described. In the following description, like reference numerals will be used to refer to the portions common to the above-described retardation film, and detailed descriptions therefor will be omitted. FIG. 6 is a sectional view of a retardation film 210, corresponding to FIG. 4.

In the sectional view of FIG. 6, an inorganic film 205 of the retardation film 210 has column-like portions 205a extending from the convex portions 202b in the deposition direction D, the direction in which the inorganic material was supplied, toward regions above the concave portions 202a.

In the retardation film 210, the inorganic film 205 has clearances between the column-like portions 205a extending from the convex portions 202b, i.e., spaces above the concave portions 202a. The retardation film having the clearances between the column-like portions 205a can more effectively control the phase of light than a retardation film in which the spaces above the concave portions 202a, i.e., the clearances between the convex portions 202b, are filled with the inorganic material.

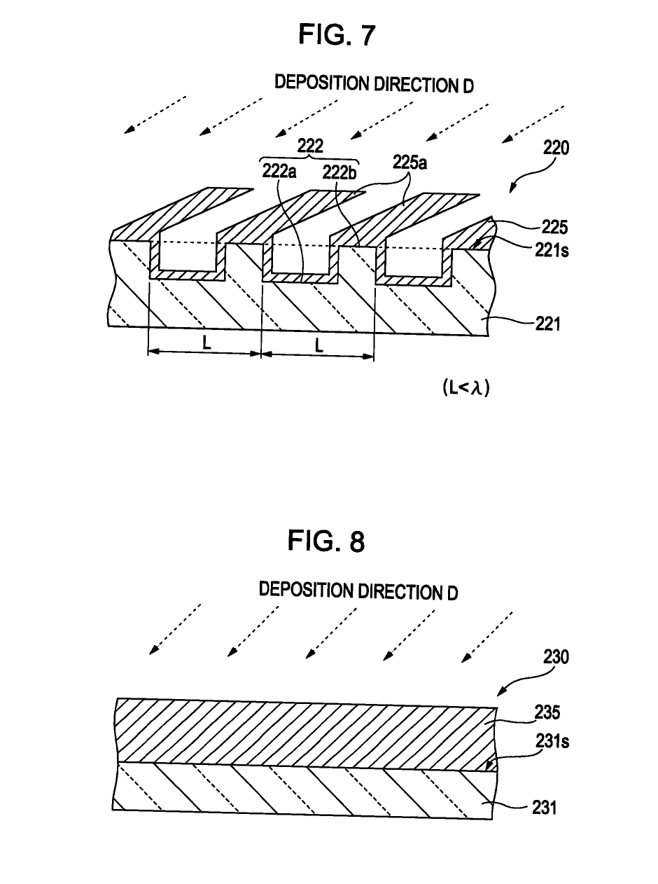

Referring to FIGS. 7 to 10, an exemplary retardation film according to a second aspect of the invention will be described.

First, referring to FIG. 7, the structure of a retardation film 220 according to the second aspect of the invention will be described. FIG. 7 is a sectional view of the retardation film 220.

Referring to FIG. 7, the retardation film 220 includes a substrate 221, such as a transparent glass substrate, a plurality of concave-and-convex regions 222 formed by partially removing a surface 221s of the substrate 221 and arranged at a pitch L smaller than the wavelength λ of visible light, each of the concave-and-convex regions 222 having a concave portion 222a and a convex portion 222b, and an inorganic film 225 formed on the concave-and-convex regions 222, in which an inorganic material is deposited on the concave-and-convex regions 222 in the deposition direction D oblique to the surface 221s.

The concave-and-convex regions 222 are formed by partially removing the surface 221s of the substrate 221 by anisotropic etching. The inorganic film 225 is formed on the concave-and-convex regions 222, using the same method used to form a film as the above-described inorganic film 205. The inorganic film 225 has column-like portions corresponding to the shape of the underlying concave-and-convex regions 222.

The inorganic film 225 has column-like portions 225a extending from the convex portions 222b in the deposition direction D toward regions above the concave portions 222a. Therefore, similarly to the retardation film 210, in the retardation film 220, the inorganic film 225 has clearances between the column-like portions 225a extending from the convex portions 222b, i.e., spaces above the concave portions 222a. The retardation film having the clearances between the column-like portions 225a can more effectively control the phase of light than a retardation film in which the spaces above the concave portions 222a, i.e., the clearances between the convex portions 222b, are filled with the inorganic material.

Accordingly, similarly to the above-described retardation film 210, the retardation film 220 can control the phase of light while having a reduced thickness compared to a retardation film in which an inorganic material is deposited on a flat surface by oblique deposition or in which only concave-and-convex regions are formed. Further, because the inorganic material needs to be deposited on only one surface of the substrate 221 in the retardation film 220, the process of manufacturing the retardation film is simpler than that in which the inorganic film needs to be formed on both surfaces of the substrate. In addition, generation of haze can be reduced.

In the retardation film 220, similarly to the retardation film 200, as long as the inorganic film is formed on the concave-and-convex regions and has the column-like portions extending in the deposition direction, a certain phase control effect can be obtained.

In the above-described retardation films 200, 210, and 220, it is preferable that the pitch L be smaller than one-third of the wavelength λ of visible light to increase the phase control effect. More specifically, for example, when the pitch L is smaller than the wavelength of a blue light component, which has the shortest wavelength among red, green, and blue light components constituting the three primary colors of light, the phase of all these colored light components can be controlled. When the pitch L is smaller than one-third of the wavelength of a blue light component, the phase of all these colored light components can be more effectively controlled.

Now, referring to FIGS. 7 to 10, the results of the experiment conducted by the inventor will be described. In the following description, the retardation film shown in FIG. 7 will be referred to as a sample 2, and a retardation film described with reference to FIG. 8 will be referred to as a sample 1.

Referring first to FIG. 8, a retardation film 230 as the sample 1, which is used as a comparative example for the sample 2 in the below-described experiment, will be described. FIG. 8 is a sectional view of the retardation film 230.

In FIG. 8, the retardation film 230 has a substrate 231 having a flat surface 231s, and an inorganic film 235 formed thereon by obliquely depositing an inorganic material in the deposition direction D. Thus, although the inorganic film 235 has column structures in which the inorganic material has been grown in the deposition direction D, the column structures do not have the shape corresponding to the concave-and-convex regions.

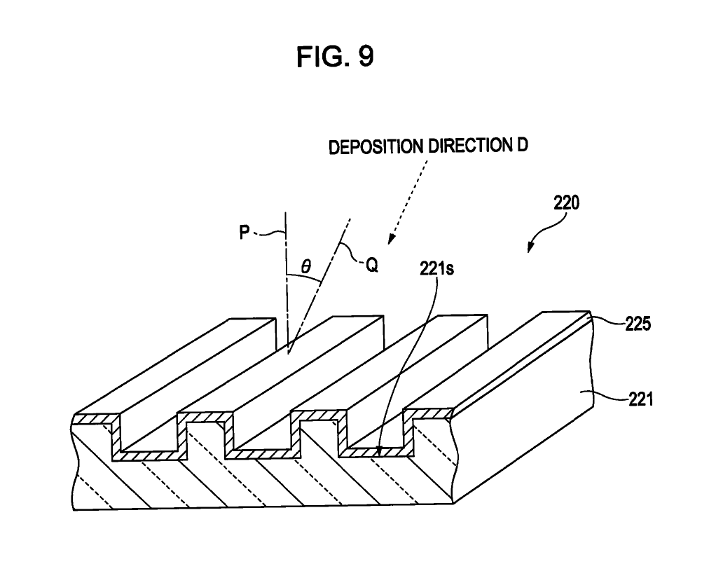

Referring to FIG. 9, the method of the experiment conducted by the inventor will be described. FIG. 9 is a perspective view of the retardation film 220 (230), schematically showing a direction in which the phase difference is measured.

As shown in FIG. 9, the angle θ, which defines the measurement direction Q in which the phase difference is measured, is inclined with respect to the normal P to the surface 221s. Herein, the angle θ inclined away from the normal P toward the deposition direction D is defined as a positive angle, and the angle θ inclined away from the normal P toward the direction opposite to the deposition direction D is defined as a negative angle. The azimuth direction of the measurement direction Q, i.e., the direction of the measurement direction Q in the in-plane direction of the surface 221s, agrees with the direction in which the deposition direction D is projected on the surface 221s.

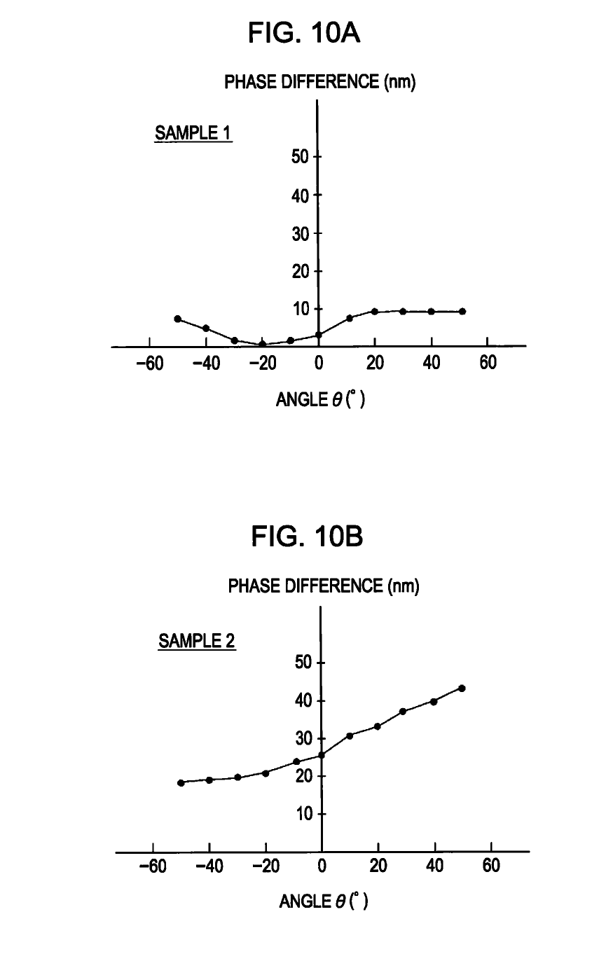

Referring next to FIGS. 10A and 10B, the results of the experiment conducted by the inventor will be described. FIG. 10A shows changes in the phase difference corresponding to changes in the angle θ for the sample 1, and FIG. 10B shows changes in the phase difference corresponding to changes in the angle θ for the sample 2.

As shown in FIGS. 10A and 10B, where the angle θ is in the range from −50° to +50°, the sample 2 produced greater phase differences than the sample 1.

Thus, the retardation film according to an aspect of the invention can control the phase of light while having a reduced thickness compared to a retardation film having an inorganic film formed on concave-and-convex regions of a substrate by perpendicular deposition, or a retardation film having only concave-and-convex regions.

As described above, the retardation film according to the present embodiment can control the phase of light while having a reduced thickness, reduce generation of haze, and simplify the process of manufacturing the retardation film.

### 3. Projection Display Apparatus

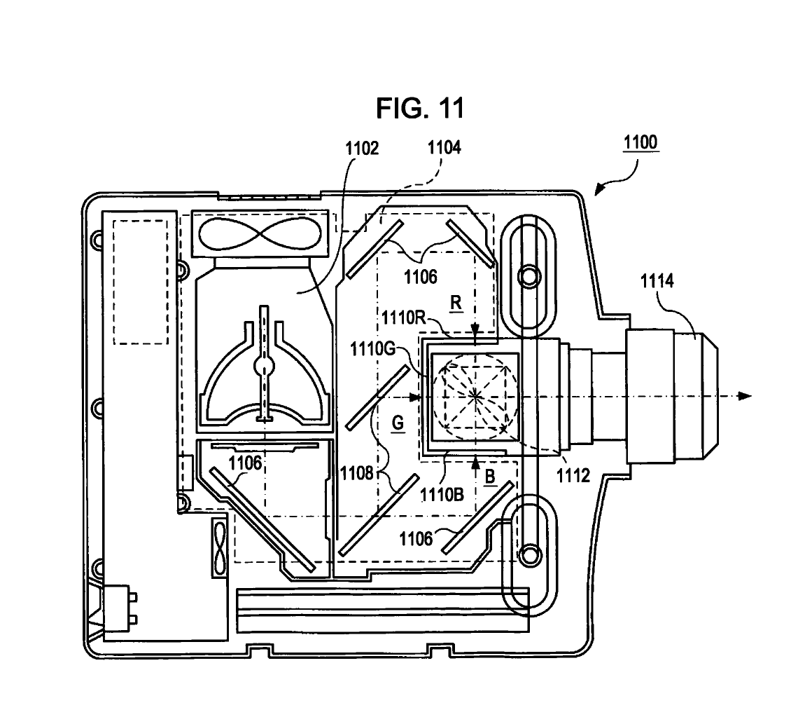

Now, an exemplary projection display apparatus that uses the above-described liquid crystal device and the retardation film will be described. The projection display apparatus according to the present embodiment is a projector having an optical system, in which the above-described liquid crystal device is used as a light valve and the above-described retardation films are arranged on both the light-incident side and the light-exit side of the light valve. FIG. 11 is a plan view of the projector according to the present embodiment.

As shown in FIG. 11, a projector 1100 contains a lamp unit 1102, which includes a white light source such as a halogen lamp. Projection light emitted from the lamp unit 1102 is separated into light components of the three primary colors, namely, red, green, and blue light components, by four mirrors 1106 and two dichroic mirrors 1108 arranged in a light guide 1104. The red, green, and blue light components respectively enters the liquid crystal panels 110R, 1110G, and 1110B, which function as the light valves corresponding to the three primary colors.

The liquid crystal panels 1110R, 1110G, and 1110B have the same structure as the above-described liquid crystal device, and are respectively driven by red, green, and blue primary color signals supplied from an image-signal processing circuit. The above-described retardation films control the phase of light entering or leaving these liquid crystal panels. After leaving the optical systems each including the liquid crystal panel and the retardation films, the light components enter the dichroic prism 1112 from three directions. The dichroic prism 1112 bends the red and blue light components by 90 degrees while allowing the green light component to pass straight therethrough. As a result of red, green, and blue images being combined, a full-color image is projected on a screen through a projection lens 1114.

Among the images projected by the liquid crystal panels 1110R, 1110B, and 1110G, the image projected by the liquid crystal panel 1110G needs to be a mirror-reversed image of the images projected by the liquid crystal panels 1110R and 1110B.

Because light is separated into red, green, and blue light components by the dichroic mirrors 1108 before entering the liquid crystal panels 1110R, 1110G, and 1110B, respectively, the liquid crystal panels do not require color filters.

Because this projector has the above-described retardation films, it can project images with enhanced contrast on a projection plane such as a screen, and can display high-quality images.

The entire disclosure of Japanese Patent Application No. 2007-184023, filed Jul. 13, 2007 is expressly incorporated by reference herein.

What is claimed is:

1. A retardation film comprising:
a substrate;
concave-and-convex regions formed on the substrate and arranged at a pitch smaller than a wavelength of visible light, each of the concave-and-convex regions having a concave portion and a convex portion; and
an inorganic film formed on the concave-and-convex regions by depositing an inorganic material on the concave-and-convex regions in a direction oblique to a surface of the substrate.

2. The retardation film according to claim 1,
wherein the concave-and-convex regions are formed by patterning a resin layer formed by applying resin onto the surface of the substrate.

3. A retardation film comprising:
a substrate;
concave-and-convex regions formed by partially removing a surface of the substrate and arranged at a pitch smaller than a wavelength of visible light, each of the concave-and-convex regions having a concave portion and a convex portion; and
an inorganic film formed on the concave-and-convex regions by depositing an inorganic material on the concave-and-convex regions in a direction oblique to the surface of the substrate.

4. The retardation film according to claim 1,
wherein the inorganic film has column-like portions extending from the convex portions toward regions above the concave portions in the direction oblique to the surface of the substrate.

5. The retardation film according to claim 1,
wherein the pitch is smaller than one-third of the wavelength of visible light.

6. A projection display apparatus comprising:
a liquid crystal device for modulating light; and
the retardation film according to claim 1 arranged on a light-incident side or light-exiting side of the liquid crystal device.
